(19) United States
(12) Patent Application Publication
(10) Pub. No.: US 2026/0197334 A1
(43) Pub. Date: Jul. 9, 2026

(54) SYSTEMS AND METHODS FOR IDENTIFYING NETWORK OPERATIONS THAT ARE INDICATIVE OF AT LEAST ONE CYBERSECURITY EVENT WHEN MONITORING NETWORK ACTIVITY

(71) Applicant: Capital One Services, LLC, McLean, VA (US)

(72) Inventors: Hassan SHALLAL, Plano, TX (US); Zhengqing LIU, Plano, TX (US)

(73) Assignee: Capital One Services, LLC, McLean, VA (US)

(21) Appl. No.: 19/088,929

(22) Filed: Mar. 24, 2025

Related U.S. Application Data
(63) Continuation of application No. 19/014,212, filed on Jan. 8, 2025.

(51) Int. Cl. H04L 9/40

(52) U.S. Cl. CPC H04L 63/1425; H04L 63/1416

(57) ABSTRACT

Systems and method for identifying anomalous network operations indicative of at least one cybersecurity event when monitoring network activity are disclosed. For example, a system can be configured to receive a dataset representing a plurality of network operations that involve at least one cybersecurity event, provide the dataset to a cybersecurity detection model to identify anomalies within the dataset, and annotate each network operation that is an anomaly with a label indicating the network operations' anomaly types, wherein at least some of the anomaly types are indicative of the at least one cybersecurity event. In some examples, the systems can be further configured to receive use input to filter the network operations and generate a graphical user interface indicating an alert when a subset of network operations that cybersecurity events are identified.

### CROSS-REFERENCE TO RELATED APPLICATIONS

This application is a continuation of U.S. patent application Ser. No. 19/014,212, filed Jan. 8, 2025. The contents of the foregoing application are incorporated herein in their entirety by reference.

### BACKGROUND

Anomaly detection methods in network security have long been pivotal in safeguarding digital infrastructures. Generally, these methods involve configuring systems to monitor network traffic and identify unusual patterns or unexpected activities represented by the network traffic that could indicate security breaches, malware activities, or unauthorized access attempts. But while these systems are adept at identifying anomalies, they often fall short in providing deeper insights into the nature of these anomalies. This lack of detailed information regarding each identified anomaly leads to several challenges.

First, while some anomaly detection algorithms can be effective at flagging outliers or deviations from the norm, they often fall short in their ability to discern between different types of anomalies. This limitation stems from their general approach, where anomalies are typically identified based on their deviation from expected patterns without considering the context or significance of these deviations. For instance, an anomaly detection system might flag both a minor system error and a sophisticated cyberattack with the same degree of urgency because it lacks the capability to understand the nature or the potential impact of these anomalies. As a result, these systems often operate with high false positive rates, overwhelming operators with alerts, many of which are insignificant. This not only leads to inefficiencies in resource allocation but also desensitizes teams to alerts, potentially missing genuinely critical threats due to alert fatigue. The inability to categorize anomalies according to their severity or type thus significantly hampers the effectiveness of anomaly detection in practical applications, necessitating more sophisticated approaches that incorporate contextual awareness and anomaly classification capabilities.

### SUMMARY

Further exacerbating these technical issues, machine learning-based techniques for classifying network operations can face significant challenges in maintaining relevance over time due to the dynamic nature of the environments they monitor. For example, machine learning models that are trained on historical data to recognize patterns that define normal and/or anomalous behavior can become outdated quickly as cybersecurity attacks become more sophisticated and pivot in their approach to evade these anomaly detectors. As a result, the training datasets used to train these models can likewise become outdated.

To keep up with these changes, machine learning models require constant updating/retraining with updated data to adapt to new patterns and maintain accuracy. The necessity for frequent retraining introduces operational overheads, including computational resources consumption involving processing and memory consumption involved in training and updating/re-training such models, time involved in validation of such models, and potential disruptions during the update process. Moreover, if not retrained adequately, these models might either fail to detect new anomalies or falsely flag legitimate changes as anomalies, leading to possibly rapid obsolescence of the model's effectiveness. This requirement for ongoing maintenance and adaptation underscores a critical limitation in deploying machine learning for anomaly detection in rapidly changing environments, highlighting the need for more adaptive systems or hybrid approaches that can learn to allow for faster model configuration and deployment.

In view of these challenges, systems and methods described herein relate to novel uses and/or improvements in anomaly and/or changepoint classification. More specifically, embodiments described herein describe the configuration of an anomaly and/or changepoint classification system(s) to analyze and classify anomalies and/or changepoints that can be identified by a separate (e.g., independent) anomaly or changepoint detection system. For example, an anomaly detection system can implement one or more anomaly detection models that analyze network operations over a period of time. This anomaly detection system can then identify and annotate network operations that represent anomalies for downstream analysis. Similarly, a changepoint detection system can implement one or more changepoint detection models that analyze network operations over the period of time and identify and annotate network operations and/or points in time that represent changepoints for downstream analysis.

An anomaly and/or changepoint classification system can then be used independent of the anomaly and/or changepoint detection system to analyze and classify each network operation. For example, the anomaly and/or changepoint classification system can analyze and classify each network operation as being a specific type of anomaly or changepoint based on aspects of the network operation, aspects of a set of network operations identified as anomalies over the period of time, or aspects of the network operations annotated as being anomalies based on the entire set of network operations for that period of time. These annotations can indicate a type of anomaly and/or changepoint represented by each network operation. And in some cases, where multiple anomalies are related to one another (e.g., representing a cluster of anomalies for a given type of anomaly), the anomaly classification system can apply multiple annotations to the involved network operations. This can allow for, among other things, downstream filtering of network operations by anomaly type during detailed analysis of the anomalous network operations.

By virtue of the implementation of the techniques described herein, network operations can be annotated and classified separately, optimizing their detection and classification. For example, an anomaly and/or changepoint detection system can implement a variety of techniques, models, etc., when identifying and annotating network operations as anomalies and/or changepoints. An anomaly and/or changepoint classification system (which can be a separate system) can then be implemented to classify each annotated network operation annotated as further being one or more types of anomalies (e.g., point anomalies, local anomalies, cluster anomalies, etc., as described herein) or changepoints. As a result, by separating anomaly and/or changepoint detection from classification, several technical improvements are realized.

First, the separate detection and classification of anomalous network operations and/or changepoints allows for a more streamlined and efficient detection process. As a result, anomaly and/or changepoint detection systems can be configured (e.g., tuned) to be as over-inclusive as desired for a given use case without impacting how the detected anomalies or changepoints are classified. Additionally, as opposed to techniques where anomaly and/or changepoint detection and classification are performed by a single system, separating detection from classification can allow for the use of statistical methods, machine learning models, threshold-based systems, etc., in either (or both) detection and classification. As a result, network operations of concern can quickly be flagged potential issues without needing deep insights into the nature of these anomalies.

Secondly, decoupling detection from classification can allow for the use of specialized algorithms for each task. For example, anomaly and/or changepoint detection algorithms can be designed for speed and broad coverage, while classification algorithms can be more complex, leveraging deeper analysis like pattern recognition, machine learning-based classifiers, etc. to categorize the anomalous network operations accurately. This specialization enhances both the speed and breadth of detection and the accuracy of classification without sacrificing the performance of one over the other.

Thirdly, it facilitates scalability and modularity. The anomaly and/or changepoint detection system can scale to handle volumes of network traffic as such network traffic changes over time, while the anomaly and/or changepoint classification system can be implemented on an as-needed basis. This separation also simplifies maintenance and updates; one can refine or replace the anomaly and/or changepoint detection system or the anomaly and/or changepoint classification system independently without the computationally-expensive and time-consuming training and updating/re-training that can be involved in updating end-to-end systems.

Lastly, the techniques described herein allow for the filtering of anomalous network operations and provide relevant alerts to be acted on. By first detecting anomalous network operations and then classifying them, the systems described herein can prioritize the information provided to individuals analyzing the overall activity on the network. This can, in turn, allow for individuals (e.g., network administrators, data scientists, etc.) to obtain relevant alerts, leading to more effective and timely analysis and remedial action. This modular approach not only enhances system performance but also allows for future updates to the anomaly detection system and anomaly classification systems, separately, to address evolutions in how network operations are developed over time.

In some aspects, systems and methods for identifying anomalous network operations that are indicative of at least one cybersecurity event when monitoring network activity represented by a plurality of network operations are described. For example, a system can receive a dataset representing a plurality of network operations. The plurality of network operations can involve at least one cybersecurity event. In examples, each network operation of the plurality of network operations can occur at a point in time within a period of time. The system can provide the dataset to a cybersecurity detection model to cause the cybersecurity detection model to generate an output. The output of the cybersecurity detection model can include a set of anomaly annotations indicating one or more anomalies. Each anomaly annotation of the set of anomaly annotations can correspond to a network operation of the plurality of network operations. The system can annotate each network operation of a set of network operations with a label. The label can indicate an anomaly type from among a plurality of anomaly types. In examples, at least one anomaly type is indicative of the at least one cybersecurity event. The system can receive user input. The user input can indicate anomaly types for filtering the set of network operations. In response to receiving the user input, the system can filter the set of network operations based on the label of each network operation and the user input to determine a subset of network operations. The subset of network operations can be classified as the at least one cybersecurity event. The system can generate a graphical user interface (GUI) based on the subset of network operations. The GUI can indicate an alert that the subset of network operations represents anomalies that are indicative of the at least one cybersecurity event.

In some aspects, systems and methods for identifying anomalous network operations that are indicative of at least one cybersecurity event when monitoring network activity represented by a plurality of network operations are described. For example, a system can receive a dataset representing a plurality of network operations. Each network operation of the plurality of network operations can occur at a point in time within a period of time. The system can determine that a set of network operations from the plurality of network operations represents anomalies based on an attribute represented by the set of network operations. The system can annotate each network operation of the set of network operations with a label. The label can indicate an anomaly type from among a plurality of anomaly types. The system can receive user input indicating at least one anomaly type to filter the set of network operations. In response to receiving the user input, the system can filter the set of network operations based on the label of each network operation and the at least one anomaly type to determine a subset of network operations. The subset of network operations can be classified as cybersecurity events. The system can generate a graphical user interface (GUI) based on the subset of network operations. The GUI can indicate an alert that the subset of network operations represents anomalies that are indicative of cybersecurity events.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative diagram for identifying anomalous network operations that are indicative of at least one cybersecurity event when monitoring network activity, in accordance with one or more embodiments.

FIG. 1B shows an illustrative diagram for identifying changepoints that are indicative of at least one cybersecurity event when monitoring network activity, in accordance with one or more embodiments.

FIG. 2A shows an illustrative diagram of anomalous network operations of a time series of network operations that are classified into one or more types, in accordance with one or more embodiments.

FIG. 2B shows an illustrative diagram 200B of changepoints represented across a set of network operations of a time series of network operations, in accordance with one or more embodiments.

FIG. 3 shows illustrative components for a system used to identify anomalous network operations that are indicative of at least one cybersecurity event when monitoring network activity, in accordance with one or more embodiments.

FIG. 4 shows a flowchart of the steps involved in a process for identifying anomalous network operations that are indicative of at least one cybersecurity event when monitoring network activity, in accordance with one or more embodiments.

FIG. 5 shows a flowchart of the steps involved in a process 500 for identifying changepoints that are indicative of at least one cybersecurity event when monitoring network activity, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form in order to avoid unnecessarily obscuring the embodiments of the invention.

To analyze the increasing amount of data exchanged and monitored across networks, it is becoming even more important to accurately detect relevant anomalous events in datasets. That being said, not all anomalous events are indicative of events where an alert is appropriate. For example, some events can be identified as anomalies due to one or more attributes of the events being outliers from a statistical perspective, but the events can otherwise be indicative of normal network activity for which an alert would not be informative. As a result, by generating alerts for these events, systems, excess system resources (e.g., processing during identification of the anomalous events and network communications involved in generating and transmitting corresponding alerts) can be consumed that could otherwise be conserved. And in the case where alerts are provided to cause an individual to review the anomalous events, such individuals can be assigned an increased number of events to investigate, resulting in alert fatigue or desensitization.

To allow for a more targeted analysis, systems are described herein that can identify and classify anomalous events (represented as entries in a dataset) through separate processes, while simultaneously parsing through irrelevant anomalous events and/or noise. This can allow for alerts to be generated when relevant anomalous events indicative of unusual behavior are identified, while forgoing alert generation for irrelevant events. By separating detection of anomalous events from their classification and annotation, these systems can be configured to be over-inclusive when initially identifying anomalous transactions while simultaneously being more precise when filtering anomalies by type (e.g., cybersecurity threats vs. noise). This, in turn, can allow for the implementation of specialized, more accurate models for spotting and categorizing anomalies, simplify updates that allow for identification of evolving threats, improve computational efficiency by simplifying training, and enhances system maintenance and scalability

The present disclosure describes systems and methods that are configured to classify network operations (e.g., representing and/or involved in executing events) that are indicative of anomalies to allow for downstream processing of these network operations. For example, systems can be configured to determine that a set of network operations from a plurality of network operations represent anomalies based on one or more attributes represented by the set of network operations. The system can then be configured to classify and annotate each network operation of the set of network operations with a label indicating an anomaly type from among a plurality of anomaly types. This can allow for the set of network operations to be filtered when performing downstream analysis of a particular type of anomalous network operation, reducing the computing resources that would otherwise be consumed when analyzing each anomalous network operation.

In addition, by separating anomaly detection from classification and annotation, systems can be configured to be over-inclusive when initially identifying anomalous network operations while simultaneously being more precise when filtering anomalous network operations by type (e.g., when removing network operations indicative of noise from the set of network operations indicative of anomalies). This, in turn, can allow for the implementation of specialized, more accurate models when spotting and categorizing anomalies, simplify updates that allow for identification of evolving threats, improve computational efficiency by separating and simplifying training such that the systems focus on a discrete task (e.g., identification or classification), and enhances system maintenance and scalability.

While the concepts described by the present disclosure are discussed in the context of network communication, the concepts described herein are applicable across a variety of industries and domains including, for example, network monitoring (e.g., detecting outages or cyber breaches), transaction monitoring (e.g., detecting fraudulent behavior involved in payment transactions), medicine (e.g., detecting abnormalities in patient's data such as irregular heartbeats), manufacturing (e.g., detecting anticipated or actual machine failures), and so on. Further, as used herein, the term “network operation” can be indicative of one or more events represented by entries within a dataset that are further represented by one or more attributes as described herein. In some examples, network operations that deviate significantly from established patterns or norms represented by one or more other network operations in the dataset can be referred to as anomalous network operations (or events that represent anomalous activity). These network operations can be characterized as unusual or rare instances that do not conform to the expected behavior of the majority of the data.

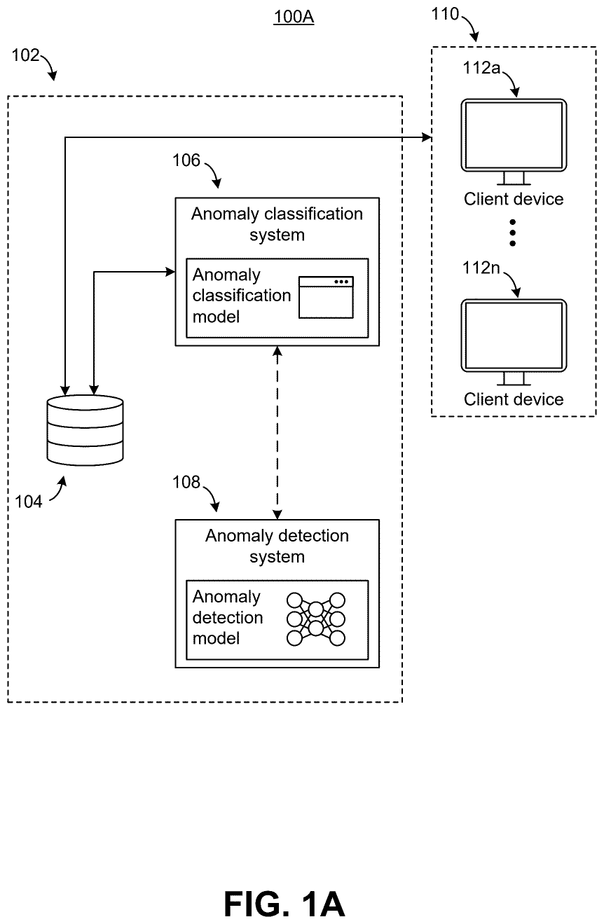

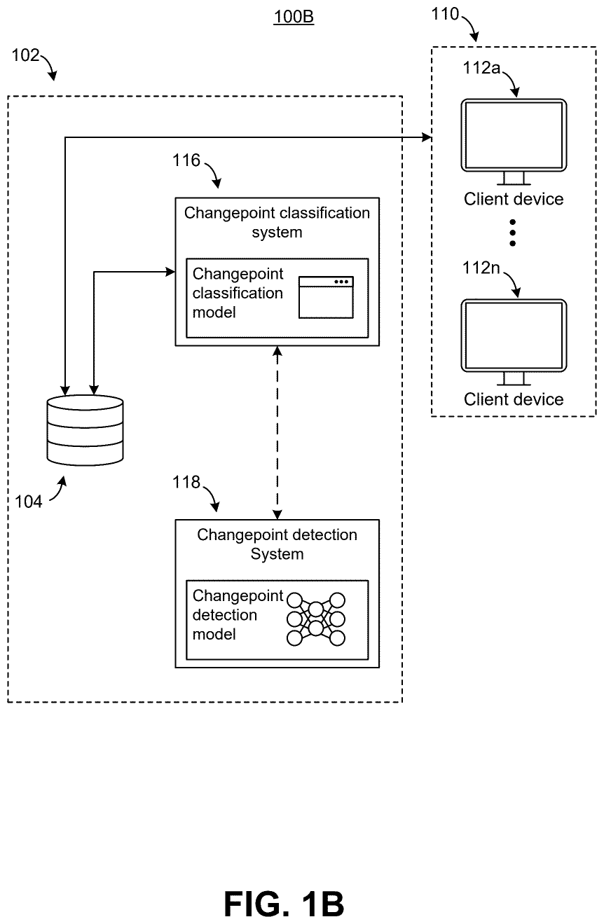

FIG. 1A shows a diagram of an environment 100A that can be configured to, among other things, identify anomalous network operations that are indicative of at least one cybersecurity event when monitoring network activity, in accordance with one or more embodiments. For example, an environment 100A can include a system 102 and a client device network 110. The system 102 (e.g., one or more components of the system 102 as described herein) and the client device network 110 (e.g., one or more client devices 112 as described herein) can be configured to interconnect using one or more wired and/or wireless connections as described herein.

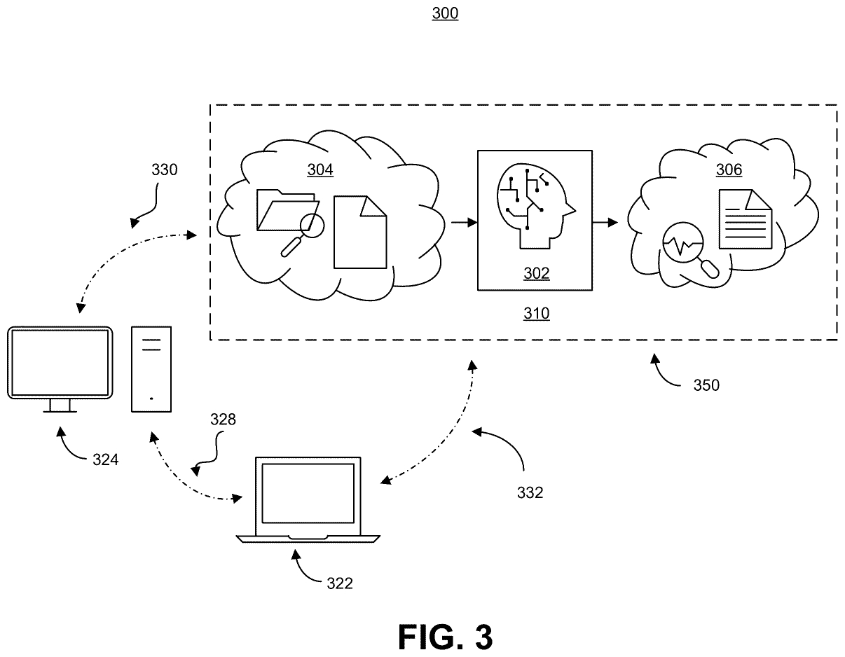

The system 102 can include a database 104, an anomaly classification system 106, and an anomaly detection system 108. However, in some examples, the system 102 can include and/or exclude one or more of the illustrated components. For example, the system 102 can include any combination of the database 104, the anomaly classification system 106, and/or the anomaly detection system 108. In examples, one or more of these components can be excluded. For example, the system 102 can include only the anomaly classification system 106. In some embodiments, the system 102 can include one or more components that are the same as, or similar to, the user terminal 324 of FIG. 3.

The client device network 110 can include, or be formed by or between, one or more client devices 112a-112n (referred to individually as a client device 112 and collectively as client devices 112, where contextually appropriate). For example, the client devices 112 can include one or more desktop computers, laptop computers, point-of-sale devices, etc., as described herein, and can be configured to communicate with one another. While illustrated as being a single client device network 110, it will be understood that multiple client devices 112 can be configured to communicate with one another, where each client device 112 is included in independent client device networks 110. In some embodiments, the client device network 110 can be established by a payment processor to process network operations (e.g., payment transactions).

The components of the system 102 can be implemented as individual devices, or can be collectively implemented by a single device or group of devices. For example, the database 104 can include one or more devices configured to be in communication with the anomaly classification system 106 and/or the anomaly detection system 108. In some embodiments, the database 104 can be configured to be in communication with one or more client devices 112 of the client device network 110. For example, the database 104 can be implemented to obtain messages passed within a network established by the client device network 110. In this example, the system 102 can implement a packet analyzer to obtain and analyze messages (e.g., network packets, etc.) communicated between the client devices 112.

The anomaly classification system 106 can include one or more devices configured to be in communication with the database 104 and/or the anomaly detection system 108. For example, the anomaly classification system 106 can include a device such as, for example, a server, a virtual machine, etc. As described herein, the anomaly classification system 106 can be configured to receive a dataset representing a plurality of network operations that represent messages passed within the network. For example, the anomaly classification system 106 can be configured to receive the dataset from the database 104 or from the anomaly detection system 108 when working in coordination to identify and classify one or more network operations that represent anomalies (referred to as anomalous network operations). And in some embodiments, the anomaly classification system 106 can be configured to communicate with a client device 112 that is part of, or separate from, the client device network 110. This can include, for example, client devices 112 controlled by individuals monitoring the network operations for anomalies that can be, for example, indicative of cybersecurity events.

In some embodiments, the anomaly classification system 106 can be associated with one or more organizations involved in monitoring network activity to identify, and in some cases address, anomalies. These organizations can include network traffic analysts, network performance management companies, financial trading networks (e.g., involved in high-frequency trading), payment processing networks (e.g., involved in processing payment transactions initiated and involving client devices 112 that are associated with merchants, customers, banks, etc.), etc.

The anomaly detection system 108 can include one or more devices configured to be in communication with the database 104 and/or the anomaly classification system 106. For example, the anomaly detection system 108 can include a device such as, for example, a server, a virtual machine implemented by the server, etc. Similar to the anomaly classification system 106, the anomaly detection system 108 can be configured to receive a dataset representing a plurality of network operations that are based on messages passed and within the client device network 110 and obtained by the database 104. For example, the anomaly detection system 108 can be configured to receive the dataset from the database 104 when working in coordination with the anomaly classification system 106 to identify and classify one or more network operations that represent anomalies. In some embodiments, the anomaly detection system 108 can be configured to communicate with a client device 112 that is part of, or separate from, the client device network 110. Again, similar to the anomaly classification system 106, the anomaly detection system 108 can be associated with one or more organizations involved in monitoring network activity to identify, and in some cases address, anomalies that can be indicative of cybersecurity events.

The anomaly detection system 108 can include one or more devices configured to be in communication with the database 104 and/or the anomaly classification system 106. For example, the anomaly detection system 108 can include a device such as a server, a virtual machine implemented by the server, etc. Similar to the anomaly classification system 106, the anomaly detection system 108 can be configured to receive the dataset representing the plurality of network operations that based on messages passed and within the client device network 110 and obtained by the database 104. For example, the anomaly detection system 108 can be configured to receive the dataset from the database 104 when working in coordination with the anomaly classification system 106 to identify and classify one or more network operations that represent anomalies. In some embodiments, the anomaly detection system 108 can be configured to communicate with a client device 112 that is part of, or separate from, the client device network 110. Again, similar to the anomaly classification system 106, the anomaly detection system 108 can be associated with one or more organizations involved in monitoring network activity to identify, and in some cases address, anomalies that can be indicative of cybersecurity events.

The client devices 112 can include one or more devices configured to be in communication with one or more other client devices 112 and/or one or more components of the system 102. For example, the client devices 112 can include a device such as a mobile device (e.g., a cellular telephone, a tablet, etc.), a laptop computer, a desktop computer, a point-of-sale device, etc. In some embodiments, the client devices 112 can be associated with one or more individuals or organizations. For example, the client devices 112 can be associated with one or more individuals or organizations involved in establishing communications therebetween. In one example, the client devices 112 can be associated with one or more merchants, one or more acquiring banks, one or more issuing banks, one or more customers, one or more service providers assisting in execution of network operations, etc. In some embodiments, the client devices 112 can include one or more components that are the same as, or similar to, the mobile device 322 of FIG. 3.

In some embodiments, the devices of the environment 100A can be configured to establish direct or indirect communication connections between one another. For example, one or more networks can establish communication paths between one or more of the devices of the environment 100A to allow for the communication of messages (e.g., network packets, etc.) therebetween. In this example, the communication paths can be the same as, or similar to, the communication paths 328, 330, and 332 of FIG. 3. The network(s) can include mobile phone networks, mobile voice or data networks, cable networks, public switched telephone networks, the Internet, or other types of communications networks or combinations of communications networks as described herein.

It will be understood that the number and arrangement of devices in the environment 100A are provided as an example and that there can be differently arranged environments than those shown in FIG. 1A. In some embodiments, at least some of the device(s) and/or system(s) of FIG. 1A can be implemented by a single device or multiple devices within a distributed system. For example, the system 102 can be implemented by a single device or as multiple devices that either alone, or in coordination, perform one or more of the operations as described herein.

With continued reference to FIG. 1A, one or more of the components of the environment 100A can be configured to identify and/or classify anomalous network operations involving one or more of the client devices 112. For example, initially, one or more of the components of the environment 100A can be configured to identify one or more network operations as anomalous network operations. Such identification can be to identify network operations representing anomalies when compared to one or more other network operations (e.g., expected network operations) that are collectively established through the communication messages between the client devices 112 of the client device network 110.

In an example, the anomaly detection system 108 can be configured to obtain (e.g., receive) a dataset that represents a plurality of network operations. The anomaly detection system 108 can receive the dataset from the database 104 as the database aggregates information about the network operations over time. Additionally, or alternatively, the anomaly detection system 108 can receive portions of the dataset from the database 104 and/or from the client devices 112 directly. For example, the anomaly detection system 108 can be implemented by the system 102 to identify anomalous network operations in real time. To do so, the anomaly detection system 108 can be configured to receive the portions of the dataset (e.g., representing individual network operation such as transactions as they are executed) from the client devices 112 and analyze the individual network operations as described herein.

In one example, the network operations can be established based on network traffic between the client devices 112 of the client device network 110. In this example, over a period of time, information about the network operations can be obtained and stored in the database 104. Aspects indicated by the network traffic can be indicative of at least one cybersecurity event. For example, the anomalous network operations representing network traffic over a period of time (e.g., days, weeks, months, or years) can indicate a variety of security breaches or threats. These can include unauthorized access attempts that can be evidenced by repeated login failures from unfamiliar IP addresses or at unusual times, data exfiltration where an unexpected amount of high-volume outbound traffic is detected, malware communication where network communications between the client devices 112 may be altered or different than what is expected, execution of fraudulent transactions, etc. Additionally, anomalies can be based on significant deviations in traffic volumes or patterns, such as sudden spikes or unusual communications which can suggest an intruder causing operations to be executed by compromised client devices 112 within the client device network 110. And in the context of payment processing, network operations representing anomalies in network traffic of a payment processing network can signal execution of unexpected payment transactions. These unexpected payment transactions can involve fraud or unauthorized activities being executed within the client device network 110. For example, payment transactions that are involved in: a sudden spike or surge in transactions involving client devices 112 controlled by a customer, merchant, bank, or service provider, transactions with values that exceeded an expected amount (for a particular account or set of accounts), etc., that deviate from typical activity across the client device network 110, changes in transaction volume from various geographical locations (e.g., locations that are distant from areas of operation associated with a given client device 112), transactions occurring outside of normal hours, etc. can be identified as anomalous network operations that are indicative of potential fraudulent activity.

In some embodiments, the plurality of network operations can be associated with (e.g., executed over) a period of time. For example, in the context of payment transaction processing, the plurality of network operations can include a set of discrete network operations that are executed at points in time within a period of time. In this example, the client devices 112 involved in the execution of the network operations (e.g., client devices 112 controlled by merchants, customers, banks for the merchants or customers, entities facilitating the transactions, etc.) can establish communication paths therebetween, exchanging messages to complete execution of each payment transaction. Information about the plurality of payment transactions representing both the communication of messages during execution and the underlying payment transaction can then be aggregated periodically, continuously, etc., at the database 104.

In some examples, a client device 112 that is controlled by an individual monitoring the network traffic between one or more other client devices 112 can establish a communication path with the system 102 and/or one or more components of the system 102. The client device 112 used by the individual monitoring the network traffic can then receive input (e.g., from the individual) and cause one or more operations to be executed by the system 102 as described herein to identify and classify anomalous network operations. For example, the individual monitoring the network traffic can provide input to the client device 112 to cause the system 102 to analyze the network operations stored in the database 104 and provide (e.g., transmit) indications of which network operations represent anomalies and/or the types of anomalies they represent. The input can further indicate a period of time during which the network operations are to be analyzed. The client device 112 can then transmit one or more messages indicating to the system 102 that a set of network operations are to be analyzed as described herein.

In some embodiments, the system 102 can analyze network operations to identify one or more of the network operations as indicative of anomalies. For example, in response to receiving messages to analyze a set of network operations from a client device 112 (e.g., controlled by the individual monitoring the network traffic), the system 102 can determine whether the corresponding network operations stored in the database 104 were previously analyzed to identify whether or not they were indicative of anomalies. In this example, the message to analyze the set of network operations can specify one or more attributes that are represented by the network operations to be analyzed. These attributes can indicate one or more of a date or range of dates to filter the network operations for analysis, one or more types of network operations (e.g., business-to-business payment transactions, business-to-consumer payment transactions, etc.), and so on. The system 102 can then analyze the dataset maintained by the database 104 to determine (e.g., identify) the set of network operations responsive to the message requesting analysis of the set of network operations from the client device 112.

Where the system 102 determines that the set of network operations have not been analyzed (e.g., to identify anomalous network operations or classify them as having one or more anomaly types), the system 102 can cause the anomaly classification system 106 and/or the anomaly detection system 108 to perform the analysis. For example, the system 102 can cause the anomaly classification system 106 to obtain a dataset from the database 104 that corresponds to the network operations involved and analyze the network operations to identify those network operations that represent anomalies. Additionally, or alternatively, where the network operations stored in the database 104 are preprocessed to identify and annotate network operations representing anomalies, the system 102 can cause the database 104 to provide the corresponding data to the anomaly classification system 106 for classification.

Where the system 102 determines that the network operations corresponding to a request from a client device 112 are not preprocessed, the system 102 can cause an anomaly detection system 108 to first obtain the set of network operations corresponding to the request in accordance with the attributes specified by the request. The system 102 can then cause the anomaly detection system 108 to analyze the network operations and identify anomalous network operations for classification as described herein. In one example, the anomaly detection system 108 can provide the dataset including the network operations responsive to the request to a model (referred to for simplicity as an anomaly detection model) implemented by the anomaly detection system 108 to cause the anomaly detection model to generate an output. The anomaly detection model can include one or more statistics-based or machine learning-based models capable of being configured to receive the dataset (or portions thereof) and generate the output. The output can identify the one or more network operations represented by the dataset that are indicative of anomalies, allowing the anomaly detection system 108 to annotate (e.g., label) the network operations accordingly. For example, the output can indicate that one or more network operations are indicative of anomalies without identifying a specific type of anomaly. As a result, the output can identify anomalies where a given network operation satisfies the criteria for a single anomaly type or multiple anomaly types, allowing for the disentanglement of anomaly detection and anomaly classification.

The anomaly detection model can include any suitable model that is trainable to identify anomalous network operations from expected or normal network operations, and can be the same as, or similar to, the model 302 of FIG. 3. For example, the anomaly detection model can include an isolation forest configured to isolate anomalies at varying depths of the isolation forest, a cluster-based model configured to group expected network operations such that anomalies are not included in the group (and are, therefore, considered to be outliers), machine learning-based models such as feed-forward neural networks, autoencoders, etc., that are configured to classify network operations as either expected or anomalous, etc. In some embodiments, the anomaly detection model can be configured to generate the output such that one or more annotations are generated. For example, the anomaly detection model can be configured to receive data associated with individual network operations or a set of network operations and generate outputs that are usable to annotate the network operations. In one example, each network operation that is identified as anomalous can be annotated by the anomaly detection system 108 as representing at least one anomaly. Additionally, or alternatively, each network operation that is not identified as being anomalous can be annotated by the anomaly detection system 108 to indicate that the network operations are not anomalies or are indicative of noise. As will be understood, the anomaly detection model can be trained using one or more supervised or unsupervised techniques. This can involve the anomaly detection system 108 training the anomaly detection model by collecting a plurality of network operations, preprocessing the network operations to clean and standardize their attributes. The anomaly detection system 108 can then provide the network operations to cause the anomaly detection model to generate an output, compare the output to an expected output (e.g., a corresponding set of network operations where anomalous network operations are labeled), and update the weights of the anomaly detection model until the model converges. This process can be iteratively repeated until anomalous network operations are identified and labeled to satisfy a threshold degree of accuracy or precision.

And in yet another example, the anomaly detection model can include a routine that is executed to determine whether each network operation represented by the dataset is complete or incomplete. In cases where the network operations are incomplete (e.g., one or more fields of the network operation are empty or null), the anomaly detection model can annotate the network operation as being an anomaly (referred to as an incomplete network operation anomaly). In cases where the network operations are complete (e.g., all of the fields associated with a given network operation are not empty or null), the anomaly detection model can annotate the network operation as not being an anomaly (or forgo annotation altogether).

In some embodiments, the anomaly detection system 108 can segment a set of network operations that are identified as anomalies from the plurality of network operations. For example, the anomaly detection system 108 can segment the set of network operations that are identified as anomalies from the plurality of network operations based on the annotations added to each network operation. In this example, the anomaly detection system 108 can cause the anomaly classification system 106 to classify each of the set of network operations segmented as anomalies from the plurality of network operations as described herein, while forgoing classification of the remaining network operations.

In some embodiments, the anomaly classification system 106 can be configured to analyze and annotate network operations to indicate their anomaly type. For example, the anomaly classification system 106 can be configured to analyze network operations that were earlier determined to be anomalies independent of the execution of operations by the anomaly classification system 106. In this example, the network operations can be determined to be anomalies by a system such as, for example, the anomaly detection system 108. The anomaly classification system 106 can then determine an anomaly type of each network application based on the analysis of the network operations and annotate the anomalous network operations to indicate their anomaly type from among a plurality of predetermined anomaly types. As described herein, the anomaly types can include local anomalies, clustered anomalies, point anomalies, clustered point anomalies (e.g., anomalous network operations that lie within a user-provided time period and include at least one point anomaly), global anomalies, cyclical and/or seasonal anomalies, etc.

In some examples, the anomaly classification system 106 analyzes and annotates network operations as being point anomalies (e.g., anomalous network operations where a given attribute's value is larger than a maximum non-anomaly observation or smaller than a minimum non-anomaly observation). These point anomalies can include network operations where one or more aspects represented by the plurality of the network operation differ significantly (e.g., by a threshold value or percentage relative to one or more other (expected) network operations). In these examples, the anomaly classification system can implement an anomaly classification model to analyze one or more aspects of the network operations when classifying them as point anomalies. The anomaly classification model can include a Z-score model (e.g., a model that implements Altman's model), an Interquartile Range (IQR) model that identifies differences, etc., that is configured to analyze individual aspects or sets of aspects of the plurality of network operations to identify outliers. These outliers can include network operations where one or more aspects represented by the network operations fall below a threshold percentile or above a threshold percentile (e.g., a 25^{th} or 75^{th} percentile, respectively) relative to the plurality of network operations being analyzed. In some embodiments, the anomaly classification model can be the same as, or similar to, the model 302 of FIG. 3

In one example, where network operations are executed using client devices 112, the anomaly classification system 106 can compare a first aspect (e.g., transaction values specified by the network operations, etc.) of each network operation annotated as an anomaly to the average for that aspect established by the plurality of network operations when determining (e.g., identifying) a first subset of network operations as point anomalies. The anomaly classification system 106 can then annotate each network operation of the first subset of network operations with a label indicative of point anomalies. In some embodiments, the anomaly classification system 106 can further determine a second subset of network operations from the plurality of network operations that represent inliers and compare one or more threshold values established by the inliers to determine whether the first subset of network operations in fact represent point anomalies. For example, where the first aspect represents transaction values for network operations representing payment transactions, the anomaly classification system 106 can determine a second subset of network operations that includes expected network operations and establish threshold value(s) such as minimum or maximum transaction values for the second subset of network operations. The anomaly classification system 106 can then compare the threshold values to the network operations that are identified as anomalies and, where the threshold values are satisfied, label the anomalous network operations as point anomalies. Alternatively, where the threshold values are not satisfied, the anomaly classification system 106 can forgo labeling them as point anomalies. As one example, where network operations representing payment transactions are identified by the anomaly classification system 106 as being point anomalies based on the amount involved in each payment transaction, the anomaly classification system can compare the amount involved to an amount established by the expected (e.g., normal or expected) payment transactions. Where the threshold established by the expected payment transactions is exceeded by the network operation(s) identified as point anomalies, the anomaly classification system 106 can annotate them as point anomalies. Where the threshold is not exceeded, the anomaly classification system 106 can forgo annotating them as point anomalies.

In some examples, the anomaly classification system 106 can analyze and annotate network operations as being contextual anomalies (or “local” anomalies). These contextual anomalies can include network operations that are identified as anomalies and occur within a specific context or as a result of a specific sequence. In these examples, the anomaly classification system 106 can implement an anomaly classification model to analyze one or more aspects of the network operations to classify anomalies that are indicative of a specific sequence of events having occurred. Where one or more aspects defining a sequence are satisfied (e.g., a set of purchases is made for a particular purpose, such as travel planning, using a client device 112 for a particular individual), the anomaly classification system 106 can determine that the sequence is satisfied and that the anomalous network operation is indicative of a contextual anomaly. The anomaly classification system 106 can then label the anomalous network operation as being a contextual anomaly.

In examples, the anomaly classification system 106 can analyze and annotate network operations as being clustered (e.g., “collective”) anomalies. These clustered anomalies can include a group of network operations that are annotated as being anomalies and exhibit attributes that are coordinated across the group. In these examples, the anomaly classification system 106 can implement an anomaly classification model to analyze one or more aspects of the network operations to classify the anomalies that are indicative of coordinated behavior. In one example, where multiple client devices 112 are being controlled (e.g., by a malicious third party) to coordinate a distributed denial of service (DDoS) attack, the anomaly classification system 106 can analyze network operations (e.g., hits to a webpage) during a period of time when a server (not explicitly illustrated) is being targeted by the DDoS attack. The anomaly classification system 106 can then determine that, based on the traffic volume during the period of time, the size, type and frequency of the messages transmitted by various client devices 112 to the server during the period of time, etc., one or more network operations that are identified as anomalies and initiated by the various client devices 112 during the attack are cluster anomalies. The anomaly classification system 106 can then label each of these network operations as clustered anomalies.

In some embodiments, the anomaly classification system 106 can annotate one or more network operation as cluster anomalies (e.g., anomalous network operations that exist within a user-provided time period relative to one or more other anomalous network operations) based on the anomaly classification system 106 determining an evaluation window of a period of time that encompasses the network operations. Again, in the context of DDoS attacks, the anomaly classification system 106 can first determine an evaluation window of a period of time that encompasses a point in time when an anomalous network operation is executed (e.g., a network operation corresponding to a known attack). The anomaly classification system 106 can then compare one or more aspects of the anomalous network operation (e.g., a “first” anomalous network operation analyzed by the anomaly classification system 106) to one or more other anomalous network operations that are within that period of time established by the evaluation window. Where the aspects of each of the one or more other anomalous network operations indicate that a pattern is established (e.g., that the network operations were all addressed to the server that was involved in the DDoS attack), the anomaly classification system 106 can determine that the one or more other anomalous network operations may be involved and subsequently label the one or more other anomalous network operations as cluster anomalies. As will be understood, the evaluation window described can extend before or after the point in time at which the first anomalous network operation was executed. Further, this process can be iteratively repeated for each anomalous network operation that falls within the initial or subsequent evaluation windows, allowing for the evaluation window to shift as anomalous network operations are identified and labeled as cluster anomalies. This can, in turn, allow for the dynamic expansion of the overall evaluation window for a given set of network operations that are cluster anomalies.

In some embodiments, the anomaly classification system 106 can annotate the network operations that are determined to be both point anomalies and cluster anomalies as joint anomalies. For example, where a cluster of network operations is identified as point anomalies and cluster anomalies, the anomaly classification system 106 can determine that each network operation of the cluster of network operations is a joint anomaly and annotate them with labels indicating they are joint anomalies. In this way, the anomaly classification system 106 can consolidate multiple labels into a single label, allowing for streamlined filtering as described herein.

In examples where the anomaly classification system 106 does not identify a given network operation that is annotated as being an anomaly as further having a specific anomaly type (e.g., as being a point anomaly, a local anomaly, a cluster anomaly, a joint anomaly, etc.), the anomaly classification system 106 can annotate the network operation as noise and/or remove the annotations indicating that the network operation is an anomaly. As a result, the anomaly classification system 106 can disassociate the network operations identified as noise from the first subset of network operations that are indicative of anomalies.

In some embodiments, the anomaly classification system 106 can classify network operations that are anomalies based on a comparison of the network operations to one or more historical network operations. For example, where a plurality of network operations executed at a first point or period in time are being analyzed, the anomaly classification system 106 can compare aspects of the plurality of network operations to one or more historical network operations that were executed at a second point or period of time earlier than the first period. Based on this comparison, the anomaly classification system 106 can then identify patterns indicative of cyclical and/or seasonal anomalies as described herein.

To compare the plurality of network operations and identify patterns therein, the anomaly classification system 106 can first obtain the historical network operations from the database 104. In this example, the anomaly classification system 106 can obtain the historical network operations based on one or more aspects of the plurality of network operations. In one example, to determine whether the plurality of network operations are associated with a period of time are recurring (e.g., at times during a day, one or more days of the week, one or more months, etc.), the anomaly classification system 106 can obtain the historical network operations that correspond to possible recurring period (e.g., similar times during the day, similar days of the week prior, similar months of years prior, etc.). These historical network operations can occur at points in time within one or more second periods of time that are different from (e.g., earlier than) the points in time of the first period in time. The anomaly classification system 106 can then compare the aspects of the network operations in the historical dataset to the aspects of the plurality of network operations being analyzed to identify patterns indicative of cyclic or seasonal anomalies.

In some examples, when identifying patterns, the anomaly classification system 106 can first analyze the historical network operations using one or more traffic analysis techniques. These can include, for example, analyzing the network operations to determine that a volume of network operations during a particular period of time, aspects of the network operations (e.g., amounts involved in various payment transactions, etc.) are similar during the particular period of time, and so on. For example, the anomaly classification system 106 can compare the historic network operations and/or the plurality of network operations and determine a pattern represented at a recurring period of time. Examples can include increases in network operations executed during a particular part of a day or week (e.g., indicative of users engaging in routine tasks), increases in values associated with network operations (e.g., increases in energy purchases during non-temperate portions of the year where energy charges can increase; increases in goods related to increases in energy purchases such as the purchase of air conditioners in a region subject to high temperature weather, increases in purchases during particular days or holiday seasons, etc.), and so on. Once identified, the anomaly classification system 106 can determine that a subset of network operations from the plurality of network operations (compared to the historical network operations) satisfy one or more patterns that are indicative of cyclic anomalies. The anomaly classification system 106 can then annotate such network operations with a label to indicate that they are cyclic anomalies.

In examples, after the anomaly classification system 106 identifies a subset of network operations from the plurality of network operations as indicative of cyclic anomalies, the anomaly classification system 106 can remove the network operations from the set of network operations identified as anomalies. For example, the anomaly classification system 106 can determine that cyclic network operations associated with a given pattern are permitted (e.g., cyclic anomalies that are not indicative of cybersecurity events, fraudulent activity, etc.). The anomaly classification system 106 can then analyze the anomalous network operations to determine whether they satisfy the pattern and, where satisfied, annotate and/or remove such anomalous network operations from the set of network operations representing anomalies.

In some examples, the anomaly classification system 106 can identify a subset of network operations from the plurality of network operations as being indicative of cyclic anomalies that are seasonal (e.g., that occur on an annual basis). For example, the anomaly classification system 106 can first obtain historical network operations and divide the historical network operations according to one or more time periods corresponding to seasons. The anomaly classification system 106 can then determine that a pattern recurs across anomalous network operations during particular seasons (e.g., during a particular set of months, set of weeks, or days). In some examples, the pattern can be established by comparing a number of anomalies and/or types of anomalies within a given season against other seasons to determine which anomalous network operations represent seasonal anomalies. The anomaly classification system 106 can then annotate the anomalous network operations with a label indicating they are seasonal anomalies and/or remove them from the set of network operations identified as anomalies. As will be understood, anomalous network operations that represent seasonal anomalies and/or cyclic anomalies can also be classified by the anomaly classification system 106 as being point, local, clustered, or clustered point anomalies.

As described, the set of network operations representing anomalies can be updated based on one or more annotations applied to respective network operations as described herein. For example, as the anomaly classification system 106 analyzes the anomalous network operations and identifies one or more as being point anomalies, cluster anomalies, cyclic anomalies, etc., the anomaly classification system 106 can update the set of anomalous network operations and appending labels to each classified anomalous network operation. And in some examples, where network operations remain unclassified, the anomaly classification system 106 can update the set of network operations by removing those that remain unclassified.

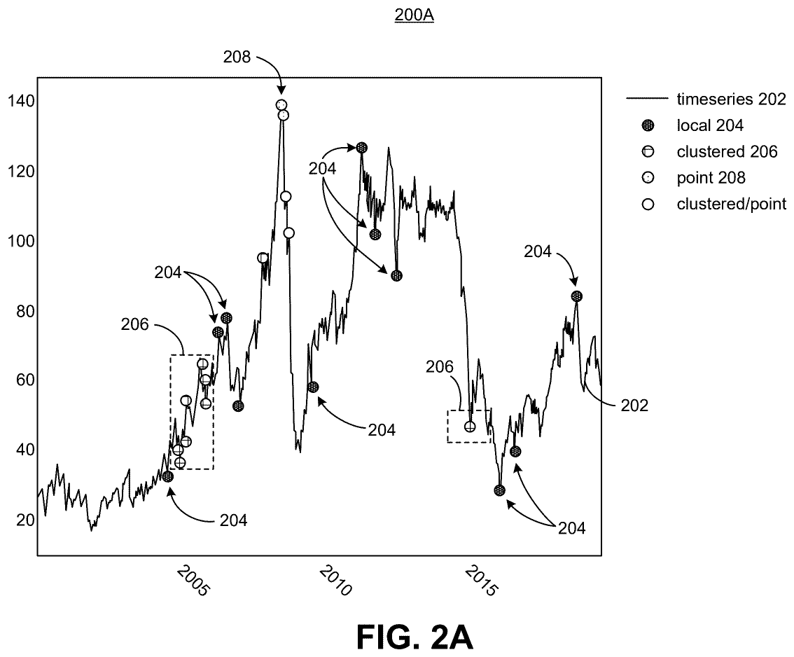

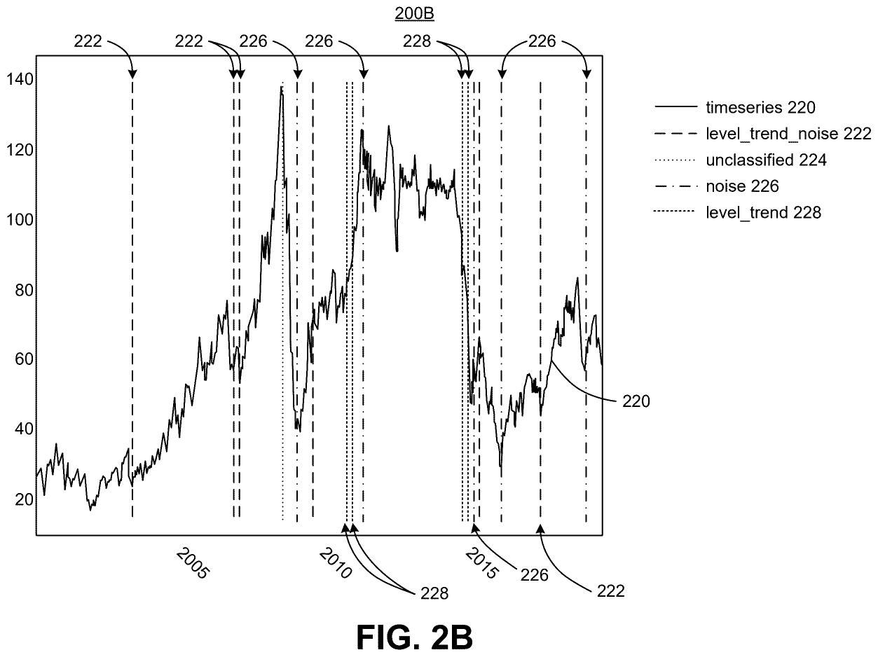

With continued reference to FIG. 1A, when the plurality of network operations is analyzed to identify and/or classify those from the set of network operations that represent anomalies, the system 102 can receive a message from a client device 112 controlled by an individual monitoring the network traffic requesting information about anomalous network operations. For example, the individual can provide input requesting information about all of the network operations that represent anomalies that are executed over a period of time (e.g., the last week, last month, etc.). The system 102 can then obtain the set of network operations representing anomalies from the database 104 and generate graphical user interface (GUI) data associated with one or more GUIs to be presented on the client device 112. The GUI data can be configured to cause a display device of the client device 112 to display the requested information. In some embodiments, the GUI can include information about specific network operations that are identified as anomalies. Additionally, or alternatively, the GUI can include a diagram of a time series of all network operations analyzed over the period of time, where anomalous network operations are updated (e.g., highlighted, etc.) to indicate the points in time at which they were executed. In this example, the anomalous network operations can also be represented such that their classification is identified in the diagram. For example, the anomalous network operations can be separated by color coding, etc., to indicate that one or more of the identified anomalies are point anomalies, cluster anomalies, etc. An example of such a GUI is illustrated and described with respect to FIG. 2A.

In some embodiments, the system 102 can receive the message from the client device 112 controlled by the individual monitoring the network traffic, where the message includes an indication of one or more types of anomalies to be filtered. For example, the individual can provide input to the client device 112 requesting information about network operations executed over a period of time. In this example, the message can further indicate on or more anomaly types selected by the individual to be filtered. In response to receiving the message, the system 102 can obtain the network operations that satisfy a time period specified by the message from the database 104 and filter the network operations such that only a subset of anomalous network operations responsive to the message are indicated. The system 102 can then generate GUI data associated with one or more GUIs to be presented on the client device 112, where the GUIs include information about the specific network operations that are identified as anomalies and responsive to the message. Additionally, or alternatively, the GUI can include a diagram of a time series of all network operations analyzed over the period of time, where anomalous network operations responsive to the message are updated (e.g., highlighted, etc.) to indicate the points in time at which they were executed. In this way, the system 102 can filter and provide GUI data indicative of cybersecurity events, fraud, etc., that is relevant to the individual without highlighting other anomalous network operations that the individual is not monitoring. In this way, network operations can be filtered to help individuals monitoring network activity (e.g., analysts) focus on types of anomalies that are mostly related to the aspects of network activity they are currently investigating. And by categorizing anomalies into one of a handful of categories to help identify which anomalies require further investigation, such individuals will be subject to a drastically reduced number of false positive alerts that they would otherwise have to investigate and/or analyze. This in turn leads to less alarm fatigue and/or desensitization and improves the efficiency and accuracy of interpreting tens if not hundreds of network operations that are identified as anomalies when detected over many time series or segments.

In some embodiments, the message provided by the client device 112 controlled by the individual monitoring the network operations can include a request to generate one or more alerts when a subset of network operations representing anomalies are identified. For example, the individual can provide input to the system 102 via the client device 112 to set up a monitoring routine. In this example, the client device can generate a message as described herein, where the message further indicates that GUI data should be provided periodically or continuously as network operations responsive to the message are identified and classified by the components of the system 102. As a result, the system 102 can generate GUIs that are responsive to the message and in accordance with the monitoring routine, and provide corresponding GUI data to alert the individual monitoring the network operations.

FIG. 1B shows an illustrative diagram for identifying changepoints that are indicative of at least one cybersecurity event when monitoring network activity, in accordance with one or more embodiments. For example, an environment 100B can include a system 102′ and a client device network 110. The system 102′ (e.g., one or more components of the system 102′ as described herein) can be the same as, or similar to, the system 102 of FIG. 1. Components of FIG. 1A with common or similar reference numerals in FIG. 1B can be the same as, or similar to, one another and can execute operations that are the same as, or similar to, those described in with respect to both FIGS. 1A and 1B.

The system 102′ can include a database 104, a changepoint classification system 116, and a changepoint detection system 118. However, in some examples, the system 102′ can include and/or exclude one or more of the illustrated components. For example, the system 102′ can include any combination of the database 104, the changepoint classification system 116, and/or the changepoint detection system 118. In examples, one or more of these components can be excluded. For example, the system 102′ can include only the changepoint classification system 116.

In some examples, the changepoint classification system 116 analyzes and annotates network operations and/or points in time associated with one or more network operations as being associated with changepoints. As described, a changepoint can indicate a point in time at which one or more attributes of one or more network operations vary such that there is a change in a level of one or more attributes represented by the network operations (e.g., a sudden, overall shift or rate of change in the attribute(s) that occurs at a point in time over a period of time). For example, changepoints can represent drastic, structural changes in attributes of network operations (e.g., representing events) in a time series. A changepoint detection system 118 can be used as described herein to identify changepoints and allow for their classification so individuals monitoring network operations over one or more periods of time can better prioritize their review of these detected changepoints. For example, in some use cases, these individuals may be monitoring these network operations by focusing on shifts in trends, while in other cases they may be focusing on shifts in volatility (variance) across individual network operations or sets of network operations.

In one example, a change in a production level from a malfunctioning machine can drops down suddenly in accordance with a first changepoint indicating that the machine is malfunctioning. Production at this reduced output level can continue until the machine is fixed and the output again increases suddenly at a second changepoint. In other examples, a changepoint can indicate a change in trend. For example, this change in trend can represent a point at which market leads have been going down in the past few months, but after a new initiative is rolled out, they start to go up again. The rollout of this new initiative can be associated with a specific changepoint. In examples, a changepoint can indicate a change in noise. This can include, for example, changes in volatility, or variance of the ways in which one or more attributes of the network operations change over time. In one example, in stock price monitoring, changepoints can indicate points in time at which there is a sudden increase in trading activity for a particular stock. And in another example, in heart rate monitoring, changepoints can indicate points in time at which an individual's heart rate increases or decreases significantly (e.g., beyond a threshold rate over a predetermined period of time). In example, changepoints can indicate recurring changes in network operations over one or more seasons. For example, a cyclic pattern represented by one or more attributes can change cyclically (e.g., daily, weekly, monthly) or seasonally (e.g., in the spring, summer, fall, etc.). In examples, changes in patterns can be implemented to allow for voice recognition as individuals' voices can vary in frequency but conform to cyclic patterns that represent a particular tone or inflection unique to an individual or group of individuals.

In some embodiments, the changepoint classification system 116 can implement a changepoint classification model to analyze one or more aspects of the network operations when classifying them as changepoints. The changepoint classification model can be configured to execute operations that implement two sample statistical comparison tests to determine whether there is a significant change in any of the attributes of the network operations before an identified changepoint and after the identified changepoint (e.g., identified by the changepoint detection system 118). Any identified changepoint can have traits associated with a given changepoint type or traits associated with multiple changepoint types. In some embodiments, the changepoint classification model can be the same as, or similar to, the model 302 of FIG. 3

In one example, where network operations are executed using client devices 112, the changepoint classification system 116 can compare a first aspect (e.g., transaction values specified by the network operations, etc.) of each network operation for a predetermined period prior to a point in time that is identified as a changepoint the first aspect as represented by each network operation for a predetermined period after the point in time. The changepoint classification system 116 can then annotate each changepoint with a label indicative of a changepoint type based on the comparison of the network operations prior to the changepoint against the network operations after the changepoint. As described above, a changepoint type can include a change in level, a change in trend, a change in noise, a change in sensitivity, etc.

As described above, the changepoint classification system 116 can classify changepoints based on their identification and annotation by a changepoint detection system 118. For example, a changepoint detection system 118 can include one or more devices configured to be in communication with the database 104 and/or the changepoint classification system 116. The changepoint detection system 118 can include a device such as, for example, a server, a virtual machine implemented by the server, etc. Similar to the changepoint classification system 116, the changepoint detection system 118 can be configured to receive a dataset representing a plurality of network operations that are based on messages passed within the client device network 110 and obtained by the database 104. For example, the changepoint detection system 118 can be configured to receive the dataset from the database 104 when working in coordination with the changepoint classification system 116 to identify and classify one or more network operations and/or points in time that represent changepoints. In some embodiments, the changepoint detection system 118 can be configured to communicate with a client device 112 that is part of, or separate from, the client device network 110. Again, similar to the changepoint classification system 116, the changepoint detection system 118 can be associated with one or more organizations involved in monitoring network activity to identify, and in some cases address, anomalies that can be indicative of cybersecurity events. Once identified, the system 102′ can generate GUI data representing the time series of network operations having one or more identified and classified changepoints. The system 102′ can then provide the GUI data to a client device 112 being controlled by an individual monitoring the network operations to cause the client device 112 to generate and output the GUI.

The changepoint detection system 118 can implement a changepoint detection model when detecting one or more changepoints within network operations over a period of time. For example, the changepoint detection system 118 can implement a changepoint detection model that includes one or more statistics-based or machine learning-based models capable of being configured to receive the dataset (or portions thereof) and generate the output. The output can identify the one or more network operations and/or points in time represented by the dataset that are indicative of changepoints, allowing the changepoint detection system 118 to annotate (e.g., label) the network operations and/or points in time accordingly. For example, the output can indicate that one or more network operations and/or points in time that are indicative of changepoints without identifying a specific type of changepoint. As a result, the output can identify changepoints where a given network operation satisfies the criteria for a single changepoint type or multiple changepoint types, allowing for the disentanglement of changepoint detection and changepoint classification. In some embodiments, the changepoint detection model can be the same as, or similar to, the model 302 of FIG. 3.

The changepoint detection model can include any suitable model that is trainable to identify changepoints based on aspects as they vary across network operations. For example, the changepoint detection model can implement a changepoint detection models that detects changepoints using one or more kernels. For example, the changepoint detection model can map the time series of network operations into a higher-dimensional feature space using a kernel function, where the differences between segments of data can be more pronounced and easier to detect. The changepoint detection model can then analyze the features over sliding windows or different periods of time to detect when the underlying statistical properties of the aspects of the network operations represented by the time series change, indicating changepoints. The use of kernels can be particularly advantageous because complex data patterns can be identified in comparison which can be missed by linear models, allowing for a domain-agnostic application of the changepoint detection model to identify changepoints. The changepoint detection system 118 can then be configured to classify network operations and/or points in time as being changepoints. In some embodiments, the changepoint detection model can be configured to generate the output such that one or more annotations are generated. For example, the changepoint detection model can be configured to receive data associated with individual network operations or a set of network operations and generate outputs that are usable to annotate the network operations. In one example, each network operation and/or point in time that is identified as a changepoint can be annotated by the changepoint detection system 118 as representing at least one changepoint. Additionally, or alternatively, each network operation and/or point in time that is not identified as being a changepoint can be annotated by the changepoint detection system 118 to indicate that the network operations and/or points in time are not changepoints or are indicative of noise. As will be understood, the changepoint detection model can be trained using one or more supervised or unsupervised techniques. This can involve the changepoint detection system 118 training the changepoint detection model by collecting a plurality of network operations, preprocessing the network operations to clean and standardize their attributes. The changepoint detection system 118 can then provide the network operations to cause the changepoint detection model to generate an output, compare the output to an expected output (e.g., a corresponding set of network operations where changepoints are labeled), and update the weights of the changepoint detection model until the model converges. This process can be iteratively repeated until changepoints are identified and labeled to satisfy a threshold degree of accuracy or precision.

FIG. 2A shows an illustrative diagram 200A of anomalous network operations of a time series of network operations that are classified into one or more types, in accordance with one or more embodiments. More specifically, the diagram 200A includes a time series 202 of network operations where a set of the network operations are labeled as being anomalies of particular types. As illustrated, the time series 202 can represent a plurality of network operations executed over a period of time (as illustrated, from approx. 2000 to 2020). The time series 202 can also include an amount of network operations that are executed per day (e.g., between 0 and 150).

In some embodiments, the plurality of network operations of the time series 202 can be analyzed by an anomaly identification system (e.g., that is the same as, or similar to, the anomaly identification system 108 of FIG. 1A). Once identified, the anomalous network operations can be annotated (e.g., labeled) as being anomalies relative to the non-anomalous (expected) network operations. The anomalous network operations can then be classified using an anomaly classification system (e.g., that is the same as, or similar to, the anomaly classification system 106 of FIG. 1A). Once classified, the anomaly classification system can label the anomalous network operations in accordance with their anomaly type. For example, the anomaly classification system can annotate respective anomalous network operations as being local anomalies 204, clustered anomalies 206, point anomalies 208, and/or clustered point anomalies (not explicitly illustrated). The diagram 200A can then be used by a system (e.g., that is the same as, or similar to, system 102 of FIG. 1A) to generate GUI data and provide the GUI data to a client device for display.

FIG. 2B shows an illustrative diagram 200B of changepoints represented across a set of network operations of a time series of network operations, in accordance with one or more embodiments. More specifically, the diagram 200B includes a time series 220 of network operations where a set of the network operations are labeled as being changepoints of particular types. As illustrated, the time series 220 can represent a plurality of network operations executed over a period of time (as illustrated, from approx. 2000 to 2020). The time series 220 can also include an amount of network operations that are executed per day (e.g., between 0 and 150).

In some embodiments, the plurality of network operations of the time series 220 can be analyzed by a changepoint identification system (e.g., that is the same as, or similar to, the changepoint identification system 118 discussed with respect to FIG. 1B). Once identified, the changepoints can be annotated (e.g., labeled) as being changepoints at points in time across the time series 220. The anomalous network operations can then be classified using a changepoint classification system (e.g., that is the same as, or similar to, the changepoint classification system 116 discussed with respect to FIG. 1B). Once classified, the changepoint classification system can label the changepoints in accordance with their anomaly type. For example, the changepoint classification system can annotate respective changepoints as changepoints involving changes across attributes of network operations identified as level/trend noise 222 (e.g., indicating trends in volatility or variance of one or more attributes of the network operations included in the time series 220), unclassifiable 224 (e.g., where one or more attributes of the network operations included in the time series 220 change suddenly (e.g., beyond a threshold amount over a period of time) but are not associated with predetermined types of changepoints, noise 226 (e.g., indicating trends in volatility or variance in one or more discrete aspects of the network operations included in the time series 220 that change suddenly), and changes in trend levels 228 (e.g., indicating a change in an existing trend (e.g., a sudden increase in network operations involving one or more client devices that are included in a larger trend involving the one or more client devices) for one or more sub-periods (e.g., a given day, week, month, year, etc., of the period represented by the time series 220). The diagram 200B can then be used by a system (e.g., that is the same as, or similar to, system 102 of FIG. 1) to generate GUI data and provide the GUI data to a client device for display.

FIG. 3 shows illustrative components for a system used to identify anomalous network operations that are indicative of at least one cybersecurity event when monitoring network activity, in accordance with one or more embodiments. For example, FIG. 3 can show illustrative components for one or more autonomous models in a multi-autonomous model architecture. As shown in FIG. 3, system 300 can include mobile device 322 and user terminal 324. While shown as a smartphone and personal computer, respectively, in FIG. 3, it should be noted that mobile device 322 and user terminal 324 can be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 can alternatively be any computing device as described above, and can include any type of mobile terminal, fixed terminal, or other device. For example, cloud components 310 can be implemented as a cloud computing system, and can feature one or more component devices. It should also be noted that system 300 is not limited to three devices. Users can, for instance, utilize one or more devices to interact with one another, one or more servers, or other components of system 300. It should be noted, that, while one or more operations are described herein as being performed by particular components of system 300, these operations can, in some embodiments, be performed by other components of system 300. As an example, while one or more operations are described herein as being performed by components of mobile device 322, these operations can, in some embodiments, be performed by components of cloud components 310. In some embodiments, the various computers and systems described herein can include one or more computing devices that are programmed to perform the described functions. Additionally, or alternatively, multiple users can interact with system 300 and/or one or more components of system 300. For example, in one embodiment, a first user and a second user can interact with system 300 using two different components.

With respect to the components of mobile device 322, user terminal 324, and cloud components 310, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices can have neither user input interfaces nor displays, and can instead receive and display content using another device (e.g., a dedicated display device such as a computer screen, and/or a dedicated input device such as a remote control, mouse, voice input, etc.). Additionally, the devices in system 300 can run an application (or another suitable program). The application can cause the processors and/or control circuitry to perform operations related to generating dynamic conversational replies, queries, and/or notifications.

Each of these devices can also include electronic storages. The electronic storages can include non-transitory storage media that electronically stores information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 3 also includes communication paths 328, 330, and 332. Communication paths 328, 330, and 332 can include the Internet, a mobile phone network, a mobile voice or data network (e.g., a 5G or LTE network), a cable network, a public switched telephone network, or other types of communications networks or combinations of communications networks. Communication paths 328, 330, and 332 can separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices can include additional communication paths linking a plurality of hardware, software, and/or firmware components operating together. For example, the computing devices can be implemented by a cloud of computing platforms operating together as the computing devices.

Cloud components 310 can include model 302, which can be a machine learning model, artificial intelligence model, etc. (which can be referred collectively as “models” herein). Model 302 can take inputs 304 and provide outputs 306. The inputs can include multiple datasets, such as a training dataset and a test dataset. Each of the plurality of datasets (e.g., inputs 304) can include data subsets related to user data, predicted forecasts and/or errors, and/or actual forecasts and/or errors. In some embodiments, outputs 306 can be fed back to model 302 as input to train the model 302 (e.g., alone or in conjunction with user indications of the accuracy of outputs 306, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 302 can update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights can be adjusted to reconcile differences between the neural network's prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 302 can be trained to generate better predictions.

In some embodiments, model 302 can include an artificial neural network. In such embodiments, model 302 can include an input layer and one or more hidden layers. Each neural unit of model 302 can be connected with many other neural units of model 302. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 302 can be self-learning and trained, rather than explicitly programmed, and can perform significantly better in certain areas of problem solving, as compared to traditional computer programs. During training, an output layer of model 302 can correspond to a classification of model 302, and an input known to correspond to that classification can be input into an input layer of model 302 during training. During testing, an input without a known classification can be input into the input layer, and a determined classification can be output.

In some embodiments, model 302 can include multiple layers (e.g., where a signal path traverses from front layers to back layers). In some embodiments, back propagation techniques can be utilized by model 302 where forward stimulation is used to reset weights on the “front” neural units. In some embodiments, stimulation and inhibition for model 302 can be more free-flowing, with connections interacting in a more chaotic and complex fashion. During testing, an output layer of model 302 can indicate whether or not a given input corresponds to a classification of model 302 (e.g., an action graph, a graph characteristic, a graph value, an objective, etc.).

In some embodiments, the model (e.g., model 302) can automatically perform actions based on outputs 306. In some embodiments, the model (e.g., model 302) can not perform any actions. The output of the model (e.g., model 302) can be used to generate a response in a user interface.

System 300 also includes API layer 350. API layer 350 can allow the system to generate summaries across different devices. In some embodiments, API layer 350 can be implemented on mobile device 322 or user terminal 324. Alternatively or additionally, API layer 350 can reside on one or more of cloud components 310. API layer 350 (which can be a REST or Web services API layer) can provide a decoupled interface to data and/or functionality of one or more applications. API layer 350 can provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 can use various architectural arrangements. For example, system 300 can be partially based on API layer 350, such that there is strong adoption of SOAP and RESTful Web services, using resources like Service Repository and Developer Portal, but with low governance, standardization, and separation of concerns. Alternatively, system 300 can be fully based on API layer 350, such that separation of concerns between layers like API layer 350, services, and applications are in place.

In some embodiments, the system architecture can use a microservice approach. Such systems can use two types of layers: Front-End Layer and Back-End Layer where microservices reside. In this kind of architecture, the role of the API layer 350 can provide integration between Front-End and Back-End. In such cases, API layer 350 can use RESTful APIs (exposition to front-end or even communication between microservices). API layer 350 can use AMQP (e.g., Kafka, RabbitMQ, etc.). API layer 350 can use incipient usage of new communications protocols such as gRPC, Thrift, etc.

In some embodiments, the system architecture can use an open API approach. In such cases, API layer 350 can use commercial or open-source API Platforms and their modules. API layer 350 can use a developer portal. API layer 350 can use strong security constraints by applying WAF and DDoS protection, and API layer 350 can use RESTful APIs as standard for external integration.

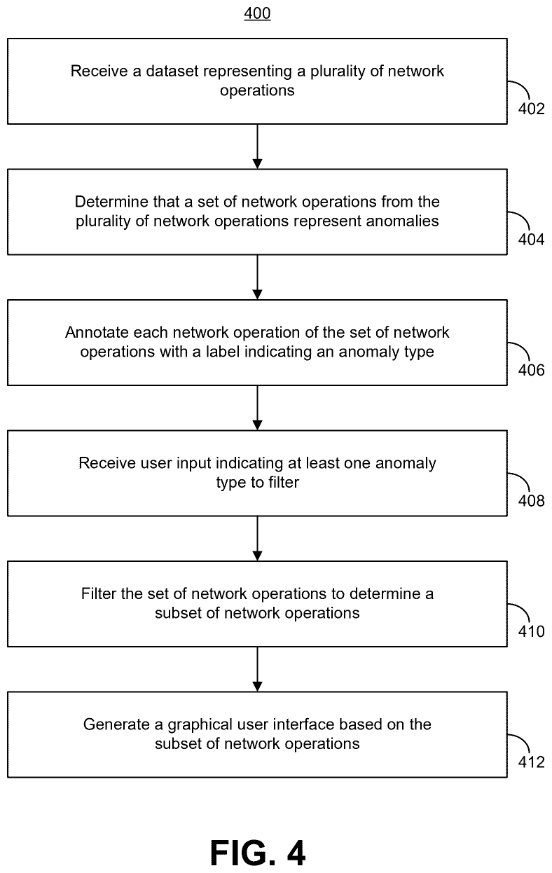

FIG. 4 shows a flowchart of the steps involved in a process 400 for identifying anomalous network operations that are indicative of at least one cybersecurity event when monitoring network activity, in accordance with one or more embodiments. For example, a system that is the same as (or similar to) the system 102 of FIG. 1A (or one or more components thereof), can implement process 400.

At operation 402, the process 400 can include receiving a dataset representing a plurality of network operations. For example, the system can receive a dataset representing a plurality of network operations. The plurality of network operations can represent a time series of network operations that are executed over a period of time (e.g., a period of days, months, years, etc.). In examples, the network operations can represent a plurality of events associated with one or more domains. For example, the network operations can represent network communications, payment transactions, or any other set of events that can be indexed in accordance with a time series.

At operation 404, the process 400 can include determining that a set of network operations from the plurality of network operations represent anomalies. For example, the system can implement an anomaly identification system 108 that is configured to receive portions of the dataset (e.g., discrete network operations, sets of network operations, sets of network operations in sequence, or the plurality of network operations). The anomaly identification system 108 can then generate an output that identifies each anomalous network operation. In this example, each anomalous network operation can be associated with one or more attributes that are outliers when compared to attributes of the other, non-anomalous network operations.

At operation 406, the process 400 can include annotating each network operation of the set of network operations with a label indicating an anomaly type. For example, the system can implement an anomaly classification system that is configured to receive the dataset (or portions thereof) and generate an output indicative of one or more anomaly types. In examples, the one or more anomaly types can include point anomalies, local anomalies, clustered anomalies, clustered point anomalies, global anomalies, cyclic and/or seasonal anomalies, etc. Once classified, the system can label each anomalous network operation accordingly. Additionally, the system can remove the remaining, unclassified anomalous network operations from the set of network operations identified as anomalies.

At operation 408, the process 400 can include receiving user input indicating at least one anomaly type to filter. For example, an individual monitoring network traffic can select one or more point anomalies and provide input to a client device (e.g., that is the same as, or similar to, the client devices 112 of FIG. 1). The input can then be communicated by the client device to the system to cause the system to filter for the identified anomaly type(s) (in this case, point anomalies) and generate a GUI that augments the corresponding network operations in the dataset. In some embodiments, the user input can also cause the client device to configure the system to generate alerts (e.g., generate and transmit GUI data as described herein) when one or more anomalous network operations responsive to the user's input are identified and classified by the system.

At operation 410, the process 400 can include filtering the set of network operations to determine a subset of network operations. For example, the system can select the network operations identified by the input as described above and generate a GUI that augments the corresponding network operations in the dataset. In some examples, this can include augmenting a color, size, etc., of the point representing the anomalous network operations. In other examples, this can include providing a listing of the anomalous network operations responsive to the individual's input. The system can then generate GUI data that is associated with the GUI. The GUI data can be configured to cause a display device of the client device controlled by the individual requesting such information. The system can then provide (e.g., transmit) the GUI data to the client device. As will be understood, the system can generate and provide the GUI data as described herein in response to the input provided by the individual. Additionally, or alternatively, the system can generate and provide the GUI data iteratively as alerts are determined to indicate the anomalous network operations responsive to the input by the individual.

At operation 412, the process 400 can include generating a graphical user interface based on the subset of network operations. For example, the client device can receive the GUI data and generate a GUI on a display device of the client device.

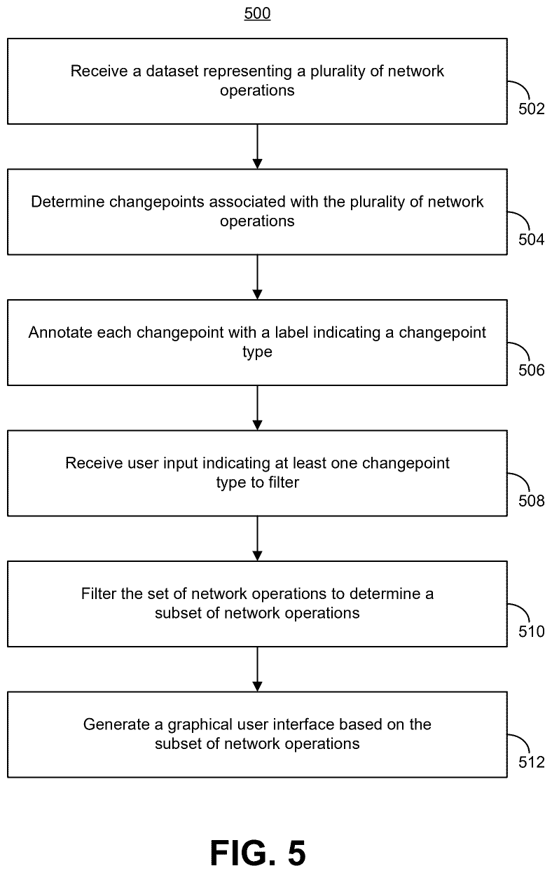

FIG. 5 shows a flowchart of the steps involved in a process 500 for identifying changepoints that are indicative of at least one cybersecurity event when monitoring network activity, in accordance with one or more embodiments. For example, a system that is the same as (or similar to) the system 102′ of FIG. 1B (or one or more components thereof), can implement process 400.

At operation 502, the process 500 can include receiving a dataset representing a plurality of network operations. For example, the system can receive a dataset representing a plurality of network operations. The plurality of network operations can represent a time series of network operations that are executed over a period of time (e.g., a period of days, months, years, etc.). In examples, the network operations can represent a plurality of events associated with one or more domains. For example, the network operations can represent network communications, payment transactions, or any other set of events that can be indexed in accordance with a time series.

At operation 504, the process 500 can include determining changepoints associated with the plurality of network operations. For example, the system can determine that a set of network operations from the plurality of network operations represent changepoints as described herein. In examples, the system can implement an changepoint identification system 108′ that is configured to receive portions of the dataset (e.g., discrete network operations, sets of network operations, sets of network operations in sequence, or the plurality of network operations). The changepoint identification system 108′ can then generate an output that identifies each network operation and/or point in time at which a changepoint is detected.

At operation 506, the process 500 can include annotating each changepoint with a label indicating a changepoint type. For example, the system can implement an changepoint classification system that is configured to receive the dataset (or portions thereof) and generate an output indicative of one or more changepoint types. In examples, the one or more changepoint types can include points in time that indicate a shift in level/trend noise, unclassifiable changepoints (e.g., where one or more attributes of the network operations included in a time series 220 change suddenly, noise, and changes in trend levels as described with respect to FIG. 2B. Once classified, the system can label each changepoint accordingly. Additionally, the system can remove the remaining, unclassified changepoints.

At operation 508, the process 500 can include receiving user input indicating at least one changepoint type to filter. For example, an individual monitoring network traffic can select one or more changepoint types and provide input to a client device (e.g., that is the same as, or similar to, the client devices 112 of FIG. 1B). The input can then be communicated by the client device to the system to cause the system to filter for the identified changepoint type(s) and generate a GUI that augments the corresponding network operations in the dataset where the changepoints occur. In some embodiments, the user input can also cause the client device to configure the system to generate alerts (e.g., generate and transmit GUI data as described herein) when one or more changepoints responsive to the user's input are identified and classified by the system.

At operation 510, the process 500 can include filtering the set of network operations to determine a subset of network operations. For example, the system can select the network operations identified by the input as described above and generate a GUI that augments the corresponding network operations in the dataset. In some examples, this can include augmenting a color, size, etc., of the network operation at the point in time representing the changepoints. In other examples, this can include providing a listing of points in time and/or network operations that are indicative of changepoints responsive to the individual's input. The system can then generate GUI data that is associated with the GUI. The GUI data can be configured to cause a display device of the client device controlled by the individual requesting such information. The system can then provide (e.g., transmit) the GUI data to the client device. As will be understood, the system can generate and provide the GUI data as described herein in response to the input provided by the individual. Additionally, or alternatively, the system can generate and provide the GUI data iteratively as alerts are determined to indicate the anomalous network operations responsive to the input by the individual.

At operation 512, the process 500 can include generating a graphical user interface based on the subset of network operations. For example, the client device can receive the GUI data and generate a GUI on a display device of the client device.

Some embodiments of the present disclosure are described in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

The above-described embodiments of the present disclosure are presented for purposes of illustration and not of limitation, and the present disclosure is limited only by the claims which follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:
1. Methods for identifying anomalous network operations that are indicative of at least one cybersecurity event when monitoring network activity.
2. The method of any one of the preceding embodiments, further comprising: receiving a dataset representing a plurality of network operations, each network operation of the plurality of network operations occurring at a point in time within a period of time; determining that a set of network operations from the plurality of network operations represent anomalies based on an attribute represented by the set of network operations; annotating each network operation of the set of network operations with a label indicating an anomaly type from among a plurality of anomaly types; receiving user input indicating at least one anomaly type to filter the set of network operations; in response to receiving the user input, filtering the set of network operations based on the label of each network operation and the at least one anomaly type to determine a subset of network operations that are classified as cybersecurity events; and generating a graphical user interface (GUI) based on the subset of network operations, the GUI indicating an alert that the subset of network operations represents anomalies that are indicative of cybersecurity events.
3. The method of any one of the preceding embodiments, wherein determining that the set of network operations from the plurality of network operations that represent anomalies comprises: providing the dataset to a model to cause the model to generate an output, the output comprising a set of anomaly annotations indicating each network operation of the set of network operations represents at least one anomaly; and segmenting the set of network operations from the plurality of network operations based on each network operation of the set of network operations corresponding to an anomaly annotation of the set of anomaly annotations.
4. The method of any one of the preceding embodiments wherein the anomaly type comprises a point anomaly, and wherein annotating each network operation of the set of network operations with the label indicating the anomaly type from among a plurality of anomaly types comprises: comparing at least one aspect of each network operation of the set of network operations to the plurality of network operations; and determining that a first subset of network operations are point anomalies in response to comparing the at least one aspect of each network operation of the set of network operations to the plurality of network operations; and annotating each network operation of the first subset of network operations with a label indicative of a point anomaly.
5. The method of any one of the preceding embodiments, wherein the set of network operations comprises a first set of network operations; and wherein determining that the first subset of network operations of the set of network operations are point anomalies comprises: determining a second set of network operations from the plurality of network operations that represent inliers; determining a threshold value established by the second set of network operations, the threshold value representing an aspect of the plurality of network operations; comparing the aspect of each network operation of the first set of network operations to the threshold value; and determining that each network operation of the first subset of network operations is a point anomaly based on the aspect of each network operation satisfying the threshold value.
6. The method of any one of the preceding embodiments, wherein the anomaly type comprises a cluster anomaly, and wherein annotating each network operation of the set of network operations with the label indicating the anomaly type from among a plurality of anomaly types comprises: determining an evaluation window of a period of time that encompasses a point in time at which each network operation is executed; determining that one or more different network operations of the set of network operations are executed at points in time within the period of time; and annotating each network operation within the period of time with a label to indicate that each network operation is a cluster anomaly.
7. The method of any one of the preceding embodiments, further comprising: determining that a first subset of network operations from the set of network operations are joint anomalies based on the first subset of network operations being labeled as point anomalies and cluster anomalies; and updating the first subset of network operations by annotating each network operation with a label indicative of a point cluster anomaly.
8. The method of any one of the preceding embodiments, further comprising: determining that a second subset of network operations from the set of network operations are not point anomalies, cluster anomalies, or point cluster anomalies; and annotating each network operation of the second subset of network operations with a second label to indicate that each network operation is a local anomaly.
9. The method of any one of the preceding embodiments, further comprising: determining that a second subset of network operations from the set of network operations that are not labeled as point anomalies, cluster anomalies, or point cluster anomalies are noise; and updating the first subset of network operations by removing each network operation of the second subset of network operations from the first subset of network operations in response to determining that the second subset of network operations are noise.
10. The method of any one of the preceding embodiments, wherein the period of time comprises a first period of time, the method further comprising: obtaining a historical dataset representing a historical network operations, each historical network operation occurring at a point in time within a second period of time that is different form the first period of time; comparing at least one aspect of the historical network operations to the plurality of network operations; and updating the set of network operations in response to comparing the at least one aspect of the historical network operations to the plurality of network operations.
11. The method of any one of the preceding embodiments, wherein comparing the at least one aspect of the historical network operations to the plurality of network operations comprises: determining a pattern represented by the historical network operations based on the at least one aspect of the historical network operations; and determining that a subset of network operations from the set of network operations satisfy the pattern indicative of a cyclic anomaly, the method further comprising: annotating the subset of network operations with a label indicating that each network operation represents the cyclic anomaly.
12. The method of any one of the preceding embodiments, wherein comparing the at least one aspect of the historical network operations to the plurality of network operations comprises: determining a pattern represented by the historical network operations based on the at least one aspect of the historical network operations; and determining that a subset of network operations from the set of network operations satisfy the pattern, and wherein updating the set of network operations comprises: removing the subset of network operations from the set of network operations.
13. The method of any one of the preceding embodiments, wherein comparing the at least one aspect of the historical network operations to the plurality of network operations comprises: comparing a set of aspects of the historical network operations to the plurality of network operations to determine a pattern indicative of a cyclic anomaly represented by the historical network operations and the plurality of network operations; and the method further comprising: annotating the subset of network operations with a label indicating that each network operation represents the cyclic anomaly in response to comparing the set of aspects of the historical network operations to the plurality of network operations.
14. The method of any one of the preceding embodiments, wherein comparing the at least one aspect of the historical network operations to the plurality of network operations comprises: determining a pattern represented by the historical network operations based on the at least one aspect of the historical network operations; and determining that a subset of network operations from the set of network operations satisfy the pattern, the method further comprising: annotating the subset of network operations with a label indicating that each network operation represents a seasonal anomaly.
15. The method of any one of the preceding embodiments, wherein comparing the at least one aspect of the historical network operations to the plurality of network operations comprises: determining a pattern represented by the historical network operations based on the at least one aspect of the historical network operations; and determining that a subset of network operations from the set of network operations satisfy the pattern, and wherein updating the set of network operations comprises: removing the subset of network operations from the set of network operations.
16. The method of any one of the preceding embodiments, wherein the anomaly type comprises an incomplete network operation anomaly, and wherein determining that the set of network operations from the plurality of network operations represent anomalies comprises: identifying network operations of the plurality of network operations comprising one or more fields that are incomplete; and determining the set of network operations represent anomalies in response to identifying the network operations comprising the one or more fields that are incomplete.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for identifying changepoints that are indicative of at least one cybersecurity event when monitoring network activity represented by a plurality of network operations, the system comprising:
one or more processors; and
one or more non-transitory, computer-readable mediums having instructions recorded thereon that, when executed by the one or more processors, cause the one or more processors to perform operations comprising:
receiving a dataset representing a plurality of network operations involving at least one cybersecurity event, each network operation of the plurality of network operations occurring at a point in time within a period of time;
providing the dataset to a changepoint classification model to cause the changepoint classification model to generate an output comprising a set of changepoint annotations indicating one or more changepoints, each changepoint annotation of the set of changepoint annotations corresponding to a network operation of the plurality of network operations;
annotating each network operation of a set of network operations with a label indicating a changepoint type from among a plurality of changepoint types, wherein at least one changepoint type is indicative of the at least one cybersecurity event;
receiving user input indicating changepoint types for filtering the set of network operations;
in response to receiving the user input, filtering the set of network operations based on the label of each network operation and the user input to determine a subset of network operations that are classified as the at least one cybersecurity event; and
generating a graphical user interface (GUI) based on the subset of network operations, the GUI indicating an alert that the subset of network operations represents changepoints that are indicative of the at least one cybersecurity event.

2. A method comprising:
receiving a dataset representing a plurality of network operations, each network operation of the plurality of network operations occurring at a point in time within a period of time;
determining that a set of network operations from the plurality of network operations that represent changepoints based on an attribute represented by the set of network operations;
annotating each network operation of the set of network operations with a label indicating a changepoint type from among a plurality of changepoint types;
receiving user input indicating at least one changepoint type to filter the set of network operations;
in response to receiving the user input, filtering the set of network operations based on the label of each network operation and the at least one changepoint type to determine a subset of network operations that are classified as cybersecurity events; and
generating a graphical user interface (GUI) based on the subset of network operations, the GUI indicating an alert that the subset of network operations represents changepoints that are indicative of cybersecurity events.

3. The method of claim 2, wherein determining that the set of network operations from the plurality of network operations that represent changepoints comprises:
providing the dataset to a model to cause the model to generate an output, the output comprising a set of changepoint annotations indicating each network operation of the set of network operations represents at least one changepoint; and
segmenting the set of network operations from the plurality of network operations based on each network operation of the set of network operations corresponding to an changepoint annotation of the set of changepoint annotations.

4. The method of claim 3, wherein providing the dataset to a model to cause the model to generate the output comprises:
executing a kernel function based on the dataset to transition the dataset from a first dimension to a second dimension, and
wherein segmenting the set of network operations from the plurality of network operations comprises:
segmenting the set of network operations based on the dataset transitioning from the first dimension to the second dimension.

5. The method of claim 2, wherein annotating each network operation of the set of network operations with the label indicating the changepoint type from among a plurality of changepoint types comprises:
determining an evaluation window of a period of time that encompasses a point in time at which each network operation is executed;
determining that one or more different network operations of the set of network operations are executed at points in time within the period of time and correspond to changepoints; and
annotating each network operation within the period of time with a label to indicate that each network operation is a changepoint having the changepoint type.

6. The method of claim 2, wherein the subset of network operations comprises a first subset of network operations, the method further comprising:
determining that a second subset of network operations are not changepoints; and
annotating each network operation of the second subset of network operations as not being changepoints.

7. The method of claim 2, further comprising:
determining that a subset of network operations from the set of network operations are noise; and
updating the subset of network operations by removing each network operation of the subset of network operations from the set of network operations in response to determining that the subset of network operations are noise.

8. The method of claim 2, wherein the period of time comprises a first period of time, the method further comprising:
obtaining a historical dataset representing a historical network operations, each historical network operation occurring at a point in time within a second period of time that is different form the first period of time;
comparing at least one aspect of the historical network operations to the plurality of network operations; and
updating the set of network operations in response to comparing the at least one aspect of the historical network operations to the plurality of network operations.

9. The method of claim 8, wherein comparing the at least one aspect of the historical network operations to the plurality of network operations comprises:
determining a pattern represented by the historical network operations based on the at least one aspect of the historical network operations; and
determining that a subset of network operations from the set of network operations satisfy the pattern indicative of a cyclic changepoint,
the method further comprising:
annotating the subset of network operations with a label indicating that each network operation represents the cyclic changepoint.

10. The method of claim 8, wherein comparing the at least one aspect of the historical network operations to the plurality of network operations comprises:
determining a pattern represented by the historical network operations based on the at least one aspect of the historical network operations; and
determining that a subset of network operations from the set of network operations satisfy the pattern, and
wherein updating the set of network operations comprises:
removing the subset of network operations from the set of network operations.

11. The method of claim 8, wherein comparing the at least one aspect of the historical network operations to the plurality of network operations comprises:
comparing a set of aspects of the historical network operations to the plurality of network operations to determine a pattern indicative of a cyclic changepoint represented by the historical network operations and the plurality of network operations; and
the method further comprising:
annotating the subset of network operations with a label indicating that each network operation represents the cyclic changepoint in response to comparing the set of aspects of the historical network operations to the plurality of network operations.

12. The method of claim 8, wherein comparing the at least one aspect of the historical network operations to the plurality of network operations comprises:
determining a pattern represented by the historical network operations based on the at least one aspect of the historical network operations; and
determining that a subset of network operations from the set of network operations satisfy the pattern,
the method further comprising:
annotating the subset of network operations with a label indicating that each network operation represents a seasonal changepoint.

13. The method of claim 8, wherein comparing the at least one aspect of the historical network operations to the plurality of network operations comprises:
determining a pattern represented by the historical network operations based on the at least one aspect of the historical network operations; and
determining that a subset of network operations from the set of network operations satisfy the pattern, and
wherein updating the set of network operations comprises:
removing the subset of network operations from the set of network operations.

14. The method of claim 2, wherein the changepoint type comprises an incomplete network operation changepoint, and
wherein determining that the set of network operations from the plurality of network operations represent changepoints comprises:
identifying network operations of the plurality of network operations comprising one or more fields that are incomplete; and
determining the set of network operations represent changepoints in response to identifying the network operations comprising the one or more fields that are incomplete.

15. One or more non-transitory, computer-readable mediums comprising instructions that, when executed by one or more processors, cause the one or more processors to perform operations comprising:
receiving a dataset representing a plurality of network operations, each network operation of the plurality of network operations occurring at a point in time within a period of time;
determining that a set of network operations from the plurality of network operations represent changepoints based on an attribute represented by the set of network operations;
annotating each network operation of the set of network operations with a label indicating an changepoint type from among a plurality of changepoint types;
receiving user input indicating at least one changepoint type to filter the set of network operations;
in response to receiving the user input, filtering the set of network operations based on the label of each network operation and the at least one changepoint type to determine a subset of network operations that are classified as cybersecurity events; and
generating a graphical user interface (GUI) based on the subset of network operations, the GUI indicating an alert that the subset of network operations represents changepoints that are indicative of cybersecurity events.

16. The one or more non-transitory, computer-readable mediums of claim 15, wherein the instructions that cause the one or more processors to determine that the set of network operations from the plurality of network operations that represent changepoints cause the one or more processors to:
provide the dataset to a model to cause the model to generate an output, the output comprising a set of changepoint annotations indicating each network operation of the set of network operations represents at least one changepoint; and
segment the set of network operations from the plurality of network operations based on each network operation of the set of network operations corresponding to an changepoint annotation of the set of changepoint annotations.

17. The one or more non-transitory, computer-readable mediums of claim 16, wherein the instructions that cause the one or more processors to provide the dataset to a model to cause the model to generate the output cause the one or more processors to:
execute a kernel function based on the dataset to transition the dataset from a first dimension to a second dimension, and
wherein the instructions that cause the one or more processors to segment the set of network operations from the plurality of network operations cause the one or more processors to:
segment the set of network operations based on the dataset transitioning from the first dimension to the second dimension.

18. The one or more non-transitory, computer-readable mediums of claim 15, wherein the instructions that cause the one or more processors to annotate each network operation of the set of network operations with the label indicating the changepoint type from among a plurality of changepoint types cause the one or more processors to:
determine an evaluation window of a period of time that encompasses a point in time at which each network operation is executed;
determine that one or more different network operations of the set of network operations are executed at points in time within the period of time and correspond to changepoints; and
annotate each network operation within the period of time with a label to indicate that each network operation is a changepoint having the changepoint type.

19. The one or more non-transitory, computer-readable mediums of claim 15, wherein the subset of network operations comprises a first subset of network operations, and
wherein in the instructions further caused the one or more processors to:
determine that a second subset of network operations are not changepoints; and
annotate each network operation of the second subset of network operations as not being changepoints.

20. The one or more non-transitory, computer-readable mediums of claim 15, wherein in the instructions further caused the one or more processors to:
determine that a subset of network operations from the set of network operations are noise; and
update the subset of network operations by removing each network operation of the subset of network operations from the set of network operations in response to determining that the subset of network operations are noise.
